(19) United States
(12) Patent Application Publication
(10) Pub. No.: US 2012/0185759 A1
(43) Pub. Date: Jul. 19, 2012

(54) SYSTEM AND METHOD FOR COLLABORATIVELY EDITING A COMPOSITE DOCUMENT

(76) Inventors: Helen BALINSKY, Cardiff (GB); Steven J. Simske, Fort Collins, CO (US)

(21) Appl. No.: 13/006,181

(22) Filed: Jan. 13, 2011

(51) Int. Cl. G06F 17/24

(52) U.S. Cl. 715/209

(57) ABSTRACT

A method and system for collaboratively editing a composite document having a plurality of original document parts. For each of one or more original document parts, a non-editable version of the original document part may be stored. Edits to the original document part may be stored in a plurality of edit parts. Each of the plurality of edit parts may be editable by a single associated one of a plurality of users and may be non-editable by all other users of the plurality of users. The plurality of edit parts may be individually encrypted and the edit parts may be stored separately from the original document parts.

### BACKGROUND

A shared digital document may be edited collaboratively in a document workflow by a plurality of user profiles in a computer network. Security for digital documents accessed by multiple computer users in multiple locations may be an important concern for businesses and other organizations using a collaborative editing process.

In a collaborative process such as a document workflow, users in multiple different locations may work to contribute material to a document, or to edit or revise the document's content. In a large organization, the users may be located all over the world or may belong to different groups, organizations, or editing teams.

### BRIEF DESCRIPTION OF THE DRAWINGS

FIG. 1 illustrates of a composite document in accordance with an embodiment of the invention;

FIG. 2 illustrates a document workflow accumulating edits from multiple users in accordance with an embodiment of the invention;

FIG. 3 illustrates of an access rights table in accordance with an embodiment of the invention; and

FIG. 4 is a process in accordance with an embodiment of the invention.

Where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of different embodiments of the invention. However, it will be understood by those of ordinary skill in the art that embodiments of the present invention may be practiced without these specific details or with other details and may be combined. In other instances, well-known methods, procedures, components, and circuits have not been described in detail so as not to obscure the present invention.

A digital document may include a composite document, which may be composed of a plurality of individually addressable and accessible parts (or units) in the form of separate files or file fragments. For example, the parts, which may be referred to as components, units or “atomic units,” may include html fragments, xml nodes, presentation slides, word processing text boxes, parts of a spreadsheet document, an electronic object containing drawings, an electronic object having flash video capabilities, or any other piece region or part of the document. Different parts of a digital document may have the same or different formats.

The digital document may be edited by a plurality of users ordered in an editing workflow. Different users in the workflow may access the document in environments with different levels of security and may be granted different access to the digital document. In an embodiment, each user may be uniquely assigned access to each part of the document on an individual, e.g., part-by-part, basis. For example, access rights to each of the original document content parts may be defined for each user as:
Read/Write (RW) access (e.g. the user may open (review) the original document content part and make changes or edits);
Read Only (RO) access (e.g. the user may open and review the original content part, but may not make changes or edits); and/or
No access (NA) (e.g. the user cannot open the original content part at all).

The access may be controlled by a subset of keys assigned to each user, which may encrypt (or may not encrypt, e.g., if the content of a part is not confidential) each of the individually addressable parts of the digital document.

In accordance with an embodiment of the invention, each specific user (profile) may have editing (RW) access to a unique user-specific editing version of the document so that users do not modify each other's edits, e.g., without breaking document integrity (authenticity). Each of a plurality of users may generate a different, separately stored, user-specific edit part (edit record or edition) to edit the same original part of the document. Together, the individual edit parts may combine to generate the cumulative edits of the plurality of users. Each user's edit parts may be saved in a separate secure file (part) to maintain a history of individual user edits. These separate edit recorded parts may ensure user accountability, regardless of subsequent modifications (by other or even the same users) that may delete or change those edits. A single designated user may have exclusive access to the associated edit parts by obtaining the required keys and security permissions, e.g. provided in the user's map files. Therefore, edits made by that specific user may be encrypted and saved in the user's associated edit parts and may be traced to that, and no other, user.

Access to edit and/or view each original (unedited) part of the digital document may be assigned to users on an individual user or group basis (e.g., via the keys assigned to each user profile). Since each user may be individually assigned access (or not) to edit each individual part of the original document, separate edit parts (e.g., and keys) may be generated in the composite document for all combinations of different users and different original document parts accessed by the respective users.

Edit parts may be initially empty files, e.g., content parts in the document serialization, which may be updated when the corresponding user edits the corresponding original part, e.g., by saving changes in a local version of the document. As the document moves through the workflow from user to user, the empty edit parts are filled with edits generated by the respective associated users for the associated parts. A chain or sequence of a plurality of edit parts (individually stored in separate memory units) may be accumulated incrementally storing the edits associated with each single original document part, where each edit part stores edits generated by a single user in the sequence of users in the workflow. Each new edits added to the chain of edit parts, once stored, cannot be edited or deleted, for full editing traceability. It may be appreciated that, although users are restricted from accessing each other's edit parts, they are not necessarily restricted from generating conflicting edits to the document. Depending on the document or workflow, a workflow participant may or may not be granted read access to edits generated by a previous workflow participant. For example, workflow participants may provide independent edits and/or comments, or alternatively, may provide mutually agreed upon final edits.

In accordance with an embodiment of the invention, a new type of access to document parts may be provided, which may for example be referred to as “Restricted Read/Write” (RRW). RRW access, like RW access, may grant the user the ability to generate and save edits to the document, but unlike RW, these edits may not be saved to the same document part being edited. RRW may be achieved through a combination of RO and RW accesses, where only RO access is given to the original document part and RW access is given to a separately stored edit part pre-designated to store the edits associated with that user and that original document part. In one implementation, RRW access may be granted to a user by providing the user with a decryption key (but not an encryption key) to view, but not edit, the original document part and an encryption key to a different address to edit the corresponding edit part.

The original content parts of the document may be “non-editable” by users, i.e., user may not have RW access (e.g., only RO or NA access) by those original parts. Although the non-editable parts may not be edited themselves, their material may be edited in the separate corresponding edit parts. Users may have RRW access to non-editable parts, where only viewing (RO) access is given to the non-editable document part and editing (RW) access is given to a separately stored pre-designated edit part.

A plurality of users may access the composite document in a workflow. A workflow may be a sequence of tasks, e.g., accesses to the same or overlapping material in a shared composite document by one or more users or one or more automatic services. Each of the users may contribute to the workflow. Contributions may vary from active editing to filling in a form, from becoming accustomed with some information to simply viewing or registering the incoming document. Problems may arise when the document workflows carries high sensitivity data but the document may be distributed through non-secure environments via potentially non-secure channels such as e-mail, compact disk (CD), memory cards, etc.

In accordance with an embodiment of the invention, the shared digital document may exist in multiple versions with varied levels of security to account for the varied levels of security in different editing environments. For example, there may be a secure document and/or an encrypted version of the secure document and/or a decrypted version of the secure document. Each different version of the document may have different user access and security parameters. When a user wishes to review or edit a document, for example, access to the secure document may be withheld, and, instead, a secured encrypted version of the document may be generated and exported from the corresponding secure document. A decrypted version of the document may be temporarily created for each user's access (for the user to edit or view the document) and may be erased when that access is completed. In one embodiment of the invention, the secure document may be a master copy (MC), the encrypted version may be a distribution version (DV) and the decrypted version may be a transient, in-memory version (IM). These document versions may be used as described, for example, in Pending U.S. Patent Application, to be filed (bearing HP docket number 201004922-1), which is hereby incorporated by reference in its entirety.

The encrypted version may be secured from hazards (attacks) characteristic of an unprotected environment. The encrypted version may further ensure that only authorized users (e.g. authorized workflow participants) may access the document or its constituent parts according to the user's granted access rights. Such differential access may be maintained, for example, through a set of map files (user-specific access key files) and an entry table (a table for locating the map file(s) for a particular user while maintaining user anonymity), included in the encrypted version. Map files and entry tables may be used as described, for example, in Pending U.S. Patent Application, to be filed (bearing HP docket number 201004922-1).

The encrypted version may store original content parts in a secure non-editable memory unit. Workflow participants may have viewing (RO) and not editing (RW) access to the original content parts, for example, as defined by the user's map files. Users may use her/his viewing (RO) access to retrieve the original content parts to view them in a local editable decrypted version.

As each user attempts to access the encrypted version of a content part, a corresponding decrypted version may be provided. Decrypted version may provide decrypted (e.g. “clear-text”) versions of those parts of the document that are (RO or RW) accessible to the user. A user (e.g., with RW access) may provide input to the document (e.g. adding, deleting or editing content) to change the decrypted parts available in the decrypted version.

A user's input may be securely stored in separate associated edit parts of the document (to which the user has exclusive editing access). These edit parts may store edits in an individually addressable and accessible memory separate from the original document part modified by the edits. Each edit part may correspond to a specific user and/or a specific original part of the document for user traceability. When the user ends an editing session, all the edits generated by the user may be encrypted and added as new (or non-empty) edit parts to update the encrypted version of the document. The edit parts may be authenticated (e.g. signed for) by the user.

As the document moves through the workflow, each user may input her/his edits into the document. Each user's edits may be encrypted, signed and saved into a corresponding encrypted edit part in the encrypted version. The corresponding edit part may be originally empty and filled with encrypted and signed edited material. Each user accessing the document in a workflow may view prior edits by decrypting the encrypted version (including all prior edit parts generated in previous stages of the workflow) to generate a decrypted version with the accumulated edits of all prior workflow participants. The encrypted version may accumulate a string of a plurality of edit parts generated cumulatively by all editors of each original part as the document moves through the workflow. In one implementation, the encrypted version may accumulate a string of a plurality of edit parts generated by a single user for all the original parts in the document edited by that single user. These strings of edit parts may be secure (non-editable) logs or histories of the edits of each part or each user in the workflow.

An administrator, workflow creator, owner, auditor and/or user with appropriate security permission may access the edit parts in the encrypted version to review the edit history of the composite document or individual document part, for example, to determine which user(s) are responsible for which edits. Edits provided by each individual workflow participant may be stored in a corresponding individual edit part that is accessible (e.g., with RW access) by the workflow participant (e.g., and no other workflow participant). Thus, these edits may be attributed exclusively to this workflow participant. Each edit part may define edits relative to the original associated document part, an edit part of a previous workflow participant, or a reference edit part, e.g., of a highest priority user or document creator.

As used herein a “composite document” may be a document having a set of individually accessible and/or separately addressable original document content parts. Original document content parts may include components (files), sub-components (file fragments) and/or component/subcomponent (file/file fragment) groupings (e.g. referred to as “tessellations,” which may be encrypted together and maintained in the encrypted document as a single content part). Where the document is a composite document, the encrypted document may ensure that each content part may be accessed only by persons who are authorized to review them.

A “component” (or “file”) may be any digital object (e.g. a file) and may include, for example, text files (e.g. *.txt files), word processing program files (such as *.doc files from Word™ by Microsoft of Redmond, Washington or *.wpd files from WordPerfect™ by Corel of Ottawa, Canada), spreadsheet program files (such as *.xls files from Excel™ by Microsoft), presentation program files (such as *.ppt files from PowerPoint™ by Microsoft) or files such as a Portable Document Format (PDF) files (e.g. *.pdf file). A component may also include any image format file, such as for example Joint Photographic Experts Group (JPEG) (e.g. *.jpg) files, Tagged Image File Format (TIFF) (e.g. *.tif) files, Portable Network Graphics (PNG) (e.g. *.png) files or Graphics Interchange (GIF) format (e.g. *.gif) files. Further, any video format file (*.mov, *.mpeg), any audio format file (e.g. mp3), or any style file (e.g. .css) may also be a component. The list above is not exhaustive and other types of files for digital objects can also serve as a component (file) in a composite document.

Sub-components (file fragments) may be individually accessible (e.g. separately addressable) units of a component, such as, for example, the fields, columns or rows in a spreadsheet file, “nodes” in a hypertext mark-up language file (HTML) (*.html, *.htm file), “nodes” from an extensible mark-up language (XML) (*.xml file), a text box or table in a word processing file, a presentation slide (e.g. from a *.ppt file) or other unit of a digital object. Sub-components may have their own access requirements and their own encryption and security keys, separate from the parent-component file. Sub-components may have ordered relationships. When combined together, sub-components may create a “one-document” appearance, for example by providing cross navigation components (e.g. hyperlinks or navigation bars) or by embedding and/or combining components together to form a page (e.g. by a layout engine).

Components and sub-components may be considered “atomic units” within a composite document. These atomic units may be the smallest units of individually accessible content in the document. The file types for components and sub-components may vary widely. A composite document may include components and sub-components having the same file format and/or file formats that are different from each other. The atomic units (components and sub-components) may also be assigned different policies for different users (e.g. different workflow participants). The same atomic unit may be assigned a first security access policy for a first user and a second security access policy for a second user.

Components and sub-components may also be aggregated or grouped into super-component-groups (or “tessellations”) to reduce the number of content parts in a composite document, as noted above in a different context. For example, where sub-components of a component have been assigned different security access policies (for example where the users in a workflow have “no access” to one set sub-component but have “Read/Write” access to a second set of sub-components), the sub-components may be extracted from the component, split into groups or tessellations according to their different access privileges.

A composite document may include components and subcomponents such as atomic units. Combinations of components and/or subcomponents may also be grouped into tessellations (according to access policies). These atomic unit groups may be aggregated for encryption and may be reassembled when decrypted.

One type of composite document format may be the .pex composite format (e.g., by Hewlett-Packard Company of Palo Alto, California). A *.pex document may be aggregated as needed per a workflow. A .pex document may include one or more typical document pieces, such as *.jpeg, *.pdf, *.doc, *.html files etc. With a *.pex document format, further component groups such as tessellations are also possible.

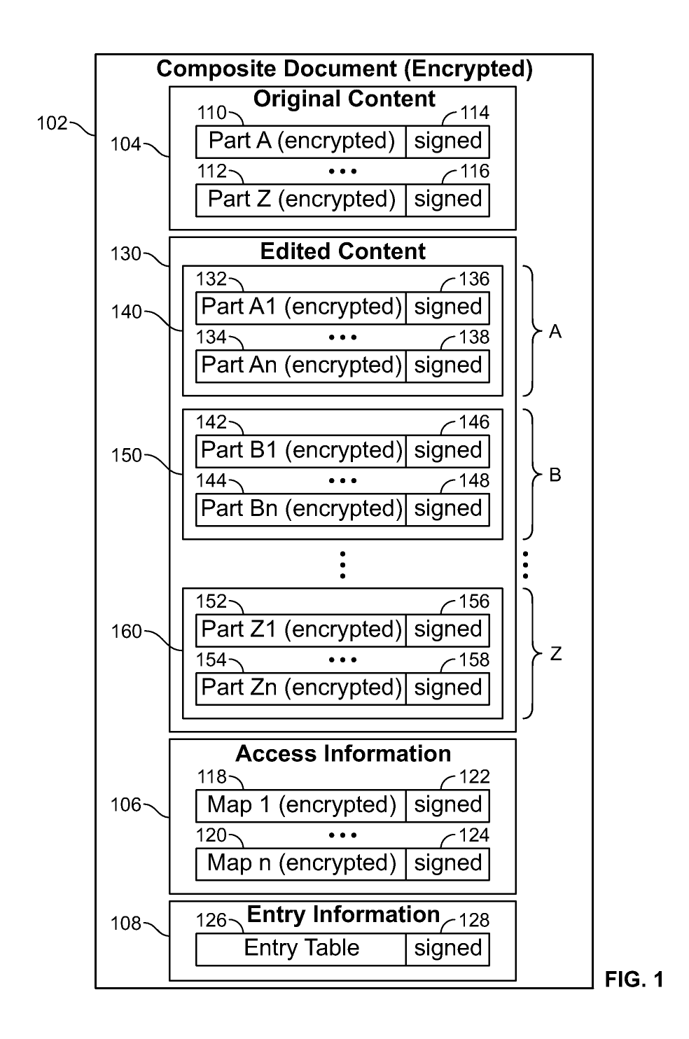

FIG. 1 illustrates a structure for composite document 102, according to an embodiment of the invention. Composite document 102 may include original content 104, edited content 130, access information (e.g. map files) 106, and entry information 108.

Original content 104 may store original material or files of composite document 102, for example, generated prior to entering the workflow (without edits acquired in the workflow). Original content 104 may be retrieved from the original secure document (a secure or master copy of the document). One or more original authors may generate original content 104 and security measures may be applied thereto to preserve edits as the documents moves along its workflow. In an embodiment in accordance with the invention, original content 104, access information 106, and entry information 108 may be protected by the security measures to prevent these components from being altered or edited in any way. Any edits or alteration of the material in original content 104 may be stored separately. For example, a decryption key may be provided to a user (e.g., via access information 106) to view (but not edit) the original material (RO access).

In an embodiment in accordance with the invention, the protective security features that protect original content 104 from being altered may be overridden, for example, by an administrator and/or original author with such permissions, to reset original content 104 to incorporate edits from edited content 130 (during or after the workflow). The reset original content 104 may form a different encrypted and/or secure document or may alter the original encrypted and/or secure document. Where multiple workflows and/or editing phases are used, original content 104 may include edits from a previous phase, which have been approved and reset as original content 104.

Original content 104 may be divided into a plurality of components or parts 110-112, e.g., parts A, B, C, . . . Z, which are individually addressable parts of the document. Each different original content part 110-112 may have a unique access code to individually grant access to each user (e.g., via the user's individual access information 106). Although access to all the original content parts 110-112 themselves may be restricted (to RO access), editing permissions may be provided thereto via separate editing parts. Since each user has access to edit original content on a part-by-part basis, access may be provided to the separate editing parts for each different combination of a user and an original content part.

Edited content 130 may store edits to original content 104 generated by users in the workflow. Edited content 130 may be stored separately from original content 104 (at a different memory address), for example, to leave original content 104 unaltered for editing traceability to an original state.

Edited content 130 may be divided into components or edit parts 132-134, 142-144 and 152-154. Editing content 130 may be divided so that each edit part may include edits uniquely associated with a different combination of a part A-Z and a user Ui-Un. For example, each original content part A, . . . Z may be edited by a plurality of edit parts A1-An, . . . Z1-Zn of edit content 130, respectively, generated a plurality of user U1, . . . Un, respectively, in a collaborative multi (n) user workflow. Edits to original content 104 parts A, B, . . . Z may be stored in edit parts (A1) 132, (B1) 142, . . . (Z1) 152 for a user U1; edit parts (A2), (B2), . . . (Z2) for a user U2; . . . edit parts (An) 134, (Bn) 144, . . . (Zn) 154 for a user Un. In some embodiment, only one or a sub-set of the original content part A, . . . Z in the document may have RRW access. Furthermore, only some workflow participants may have RRW access to a part, while others may have different access, e.g., RW, RO, or NA access. Since each original content 104 parts is associated with an edit part for each user having RRW access, if only a sub-set (less than (n)) users have RRW access to an original content 104 part, the part may have less than n associated edit parts.

Each edit part may be updated with edited content generated by a single associated user (given exclusive RW access) designated for that part (e.g., having the only set of keys to unlock that edit part). Other users may be locked out from editing parts designated to another user (e.g., having keys that cannot unlock other user's edit parts) for full user accountability. Other users may view each other's edit parts (with RO access) to build on each others' edits. Alternatively, other users may not view other user's edit parts (with NA access) to edit independently of each other. In an embodiment in accordance with the invention, a user may only unlock her/his designated edit part at a specific stage or order in the workflow. For example, user keys for a specific part may only work in a specific order or one at a time to ensure serialized editing. If the user's turn to edit a part of the document is passed and, for example, a subsequent user is editing the same part of the document, the passed user may be locked out from modifying his or her own edit part corresponding to that part of the document. In another embodiment in accordance with the invention, concurrent editing by multiple users may be allowed and may be resolved by a conflict resolution mechanism.

In an embodiment in accordance with the invention, edit parts 132-134, 142-144 and 152-154 may initially be empty files and may be updated with content each time a corresponding user generates an edit for a corresponding original part of the document. As an original part (e.g., part Q) of the document moves through the workflow, edits are added to the initially empty parts Q1, Q2, . . . Qn when the respective users U1, U2, . . . Un, (which have exclusive editing access to those parts) make edits. When a user has permission, but chooses not to edit a part, the corresponding edit part may remain empty.

As edits are generated for each original content part 110, 112 as the part moves through the workflow, a string of corresponding edit content parts 140, 160 are generated, respectively, defining the collaborative edits of a group of users.

A document master/ workflow owner may have permission to view other users' edit parts (e.g., obtaining a key for RO access), for example, to accept the edits stored, resolve an edit conflict, and/or identify a responsible user. The reviewer or non-designated users may not have (RW) access to alter or edit that user's edit part. The reviewer may retrieve an edit log to view all edits stored in the document 102 (e.g., decrypted and applied to the associated document parts). The reviewer may view the edit parts individually, for example, one-by-one, as a reviewer scans or scrolls through the edits by each sequential user in the workflow for the same original part or for different original parts generated by the same user. In an embodiment in accordance with the invention, the reviewer may view a plurality of edit parts together.

In order to control a user's access to original content parts 110, 112, and edit parts 132-134, 142-144 and 152-154, each user may be assigned access keys to each content part. The keys may be stored for each user in the user's associated map file 118-120. Access control for a content part may be enabled, in an embodiment of the invention, by for example: an encryption key (K_{E}), a decryption key (D_{E}), a signature key (K_{S}) and/or a verification key (K_{V}). Each original content parts 110, 112 may be associated with a unique encryption key (K_{E}). Users (e.g. workflow participants) who may receive a decryption key (K_{D}), corresponding to the encryption key (K_{E}), may then access the part (decrypt it and read it). After generating edits, users assigned an encryption key (K_{E}) for the part may encrypt the edited content. Users assigned a signature key (K_{S}) may sign the edited content. A user may use a verification key (K_{V}) to verify the authenticity of a part of an encrypted document upon receipt (even if they have no access). Such verification may (or may not) be required as part of the workflow, for example, to avoid corruption or modification of content parts without authorization by either the previous user (previous workflow participant) or by another person while the document is in transit. A digital signature, properly verified, may provide assurance that the content part was created by a workflow participant and that the content part was not altered in transit. Verification may be performed whether the user has RW, RRW, RO or NA rights to the content part.

Users who are given the decryption key (K_{D}), encryption key (K_{E}), digital signature key (K_{S}), and/or verification keys (K_{V}) may have “Read/Write” (RW) access. Users with RW access may be able to verify the authenticity of the content part (e.g., using the verification key K_{V}), view the content part (e.g., using the decryption key K_{D}), encrypt edited content (e.g., using the encryption key K_{E}) and/or sign edited content (.g., using the signature key K_{S}) to save the changes in the associated encrypted edit parts of the document 102. Users who are given the verification keys (K_{V}) and decryption key (K_{D}) but not the encryption key (K_{E}) or signature key (K_{S}) may have “Read Only” (RO) access. Users with RO access may be able to verify and decrypt a content part, but not save (encrypt or sign) any changes. Users who receive neither the decryption key nor the encryption key for the content part have “No Access” (NA). In one embodiment, all users may have a verification key (K_{V}) to verify the authenticity of the user. The key-map files 118-120 storing the keys for each user may be encrypted using the known user public encryption key, or using hybrid encryption: data may be encrypted by a specially generated symmetric encryption key, which is then encrypted using the user's public encryption key. In some embodiments, the identities of the users that generate edits parts may be hidden. In such embodiments, instead of using personal signature keys that identify users, users may sign edited content with different anonymous keys, e.g., a new pair of keys. Other keys or combinations or keys may be used.

In an embodiment in accordance with the invention, users may be given RO access, but not RW access, to original content parts 110, 112. To make edits to the content of original content parts 110, 112, users may be given RW access to an associated edit part. Therefore, changes made by a user (e.g., User U1) on a decrypted version of the document may not be saved back to the secure non-editable encrypted version of the original content part (e.g., part 110), but may be saved to a separate edit part (e.g., edit part 132) specifically designated for that user and that original part. A user may receive a decryption key to retrieve data from original content part (e.g., 110) and an encryption key (and signature key) to store associated edits at a separate part (e.g., edit part 132). In another example, when edit parts include a full copy of the content of the original part, the decryption and encryption keys may be assigned for the same edit part address.

Each content part of composite document 102 may be separately encrypted (e.g., in a distribution version). Each content part may be also signed by its own digital signature key. Access control for a content part may be enabled, in an embodiment in accordance with the invention, by the following keys. For example, each original part A (110) and edits part A1, . . . . An (132,134) may be encrypted with its own encryption keys E_{A}, E_{A1}, . . . E_{AN} and signed (e.g. at 114) with its own digital signature keys S_{A}, S_{A1}, . . . S_{AN}, respectively. Likewise, each original part Z (112) and edits part Z1, . . . . Zn (152,154) may be encrypted with its own encryption keys E_{Z}, E_{Z1}, . . . E_{ZN} and signed (e.g. at 116) with its own digital signature keys S_{Z}, S_{Z1}, . . . S_{ZN}, respectively.

Access information 106 may contain user access information for the document's component parts. Access information 106 may include map files 1, . . . n. (e.g. corresponding to users 1, . . . n). FIG. 1 shows map files, map 1 (118) through map n (120). Each map file may include, for example, a plurality of entries per content part. Each entry may correspond to the different accesses granted to a user for different versions of the original part and its associated edit parts. Each entry may contain, for example, a content part name (name/id, identifier) and one or more keys corresponding to access rights granted to the user (e.g. workflow participant) for the particular part. In an example that includes Read/Write, Read Only and No access, there may be, for example, the following types of entries for the access keys for each original content part:
For Read/Write (RW) access: an entry may contain the content part name and keys for: encryption, decryption, signature, and verification;
For Read Only (RO) access: and entry may contain the content part name and keys for: decryption and verification; and
For No access (NA) access: an entry may contain a key for verification, for example, and the content part name or a code name.
For Restricted Read Write (RRW) access where each user has a plurality of different accesses to each of the edit parts Ai for an original part A: an entry may contain the following access keys in the map files of the corresponding workflow participants for that part: decryption key D₀ and verification key V₀ (for read only access to the original part A), . . . decryption key Dᵢ₋₁ and verification key Vᵢ₋₁ (for read only access until the edit part Ai-1 preceding the user's designated edit part), encryption key Eᵢ, decryption key Dᵢ, signature keys Sᵢ, and verification key Vᵢ (for editing (RW) access to the user's designated edit part Ai), . . . and verification keys Vᵢ₊₁, (for no access to all edit parts succeeding the user's designated edit part). In some embodiments, only a subset of workflow participant may be assigned RRW access to a part. Accordingly, only subset of these access keys may be provided, e.g., for workflow participants who have RRW access to a particular RRW content part.

In FIG. 1, map 1 (118) through map n (120) are shown to be encrypted, e.g. using a known public encryption key. In addition, map 1 (118) through map n (120) are illustrated as signed (122, 124) using digital signature keys.

Composite document 102 may include entry information 108. Entry information 108 may provide a way for each user to obtain access to map file(s) within the composite document 102, while still maintaining privacy for the users, for example as described in Pending U.S. Patent Application, to be filed (bearing HP docket number 201004922-1). In an embodiment in accordance with the invention, a small known string of characters, e.g., a “magic” string, may be encrypted for each user. Each user may attempt to decrypt these magic strings in turn until a correctly decrypted string is found. The magic string may have a length sufficiently small so that “decrypting” the magic string does not ensure possession of the correct private key, but that possession of the correct private key may ensure than only one of the magic keys may be decrypted.

An entry table 126 may be subdivided into separate cells that may include, for example: 1) the “magic string” in clear text form; 2) the same “magic string” encrypted and 3) user entry information containing corresponding map file name/id, decryption, signature and/or verification (optional) keys. Digital signature 128 may be used for table entry 126 to verify the table entry's authenticity.

Each part of original content 104, edited content 130, access information 106 and/or entry information 108 may be individually addressable and may include one or more separate files, which may be organized together into a document serialization (e.g. in a database implementation, for example, a SQLite™ file). FIG. 1 illustrates original content 104, edited content 130, access information 106 and entry information 108 in encrypted forms, and as such, composite document 102 may be an encrypted, decrypted or secure version of a composite document. In a decrypted version, for example, a version accessed by a user during the workflow, the composite document may appear in clear text/image format and edited content 130 may be presented to a user by the application as applied to the original content 104, part by part, in sequential order of the chain of edits for each part.

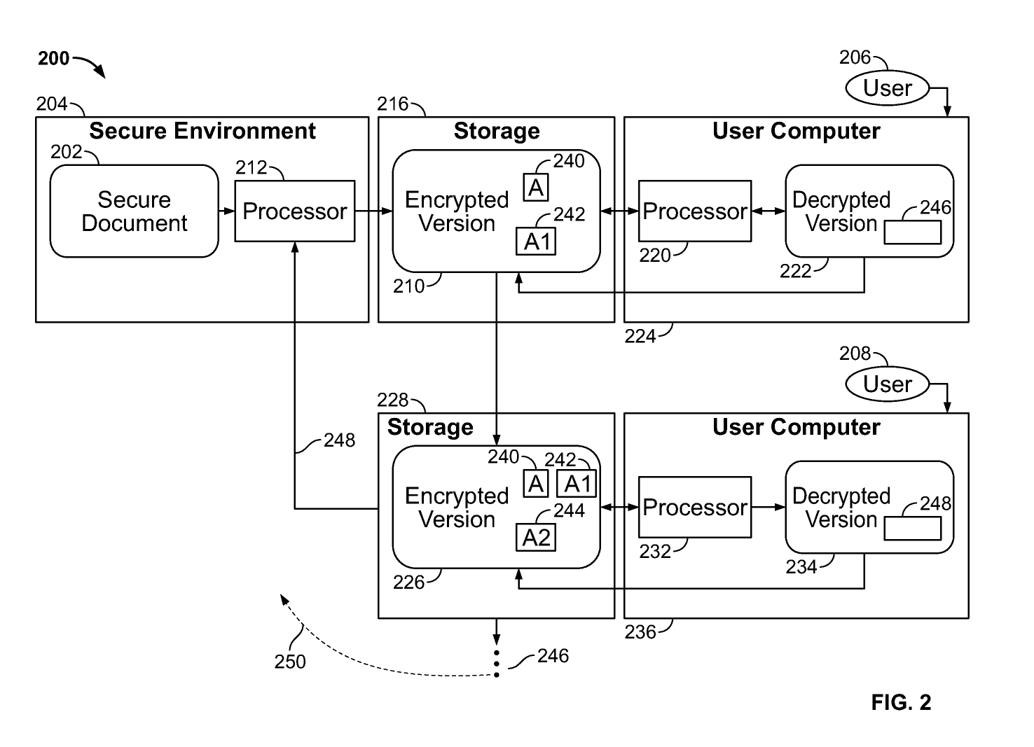

FIG. 2 illustrates a document workflow 200 accumulating edits from multiple users, in accordance with an embodiment of the invention.

A secure document 202 may be a secure copy of a document, such as a composite document, maintained in secure environment 204, such as a central server. Users 206, 208 may be participants in a workflow operating user computers 224 and 236, respectively. Users 206, 208 may have no or only limited access to secure document 202. An embodiment in accordance with the invention may provide encrypted versions 210, 226 of secure document 202 to users 206, 208. Encrypted versions 210, 226 may originate from secure document 202. When one or more of users 206, 208 may wish to access a document (e.g. secure document 202), an encrypted version 210 or 226 may be generated from secure document 202.

Encrypted versions 210, 226 may securely store the content of secure document 202, for example, as individually encrypted and signed original content parts. Encrypted versions 210, 226 may propagate to different users to accumulate edits and update users input. For example, user 206, in attempting to access secure document 202 may be provided with encrypted version 210, generated, for example, by processor 212.

Encrypted version 210 may be loaded on storage 216 (e.g. such as on a computer hard drive on a server or other computer), which may be unsecured or which may have only limited security (e.g., provided in public-shared file systems, cloud computing environments, social websites, etc.). Encrypted version 210 may be available on a network server through a file system with limited security protection. In another implementation, user 206 may receive (e.g. via disk or email) a copy of encrypted version 210. User 206 may download encrypted version 210 onto storage 216, which may be a hard drive on a personal computer.

Encrypted version 210 may ensure that only authorized users (e.g. authorized workflow participants) may access the document according to her/his granted access rights. Where the document may be a composite document that may include different content parts (e.g. components, sub-components, tessellations, etc.), encrypted version 210 may ensure that only those components within encrypted version 210 that correspond to user 206 granted rights may be accessed.

User 206 may authenticate and decrypt encrypted version 210 to generate a decrypted version 222 of secure document 202, for example, using an application program or user interface. Decrypted version 222 may include unencrypted material (clear-text copies) of content from encrypted version 210 that user 206 may be permitted to access. Accordingly, when a user does not have access to certain parts, only a partial version of encrypted version 210 may be decrypted.

Decrypted version 222 may exist in user computer 224 (e.g., in transient storage). Transient storage may be random-access memory (RAM), caches or buffers, in user computer 224. When an application program running decrypted version 222 is terminated, decrypted version 222 may be erased.

User 206 may provide input to the document (e.g. adding, deleting or editing content) by generating edited content 246 in decrypted version 222. Upon completion of an editing session by user 206, (or entry of a “save” command), processor 220 may save edits to content inserted by the user 206 to an original document part 240 (e.g., part A) to an edit part 242 associated with the original document part 240 back into the encrypted version 210, creating an updated version of encrypted version 210 without altering the original content part 240. User 206 may proceed to edit other parts B, . . . Z in decrypted version 222 of the document. Edit part B1, . . . Z1, may be generated in encrypted version 210 for user 206 to save the edits made to decrypted version 222 for each respective one of a plurality of the original content parts B, . . . Z. The original content parts A, . . . Z in the encrypted version 210 may remain unaltered by the associated edit parts A1, . . . Z1 generated by user 206. At the end of user's 206 session, user computer 224 may erase decrypted version 222 from transient storage and may also deactivate (discard) user's 206 keys.

User 208 may wish to edit the document. User 208 may receive access to encrypted version 226, for example, after user 206 edits the document or a part thereof. The order of the users 206, 208, . . . in the workflow may be predetermined. For example, one user (208) may be unable to access encryption keys or map files required to edit the document until edits are received from the one or more preceding users (206). In this way, a predetermined order of workflow may be enforced by the security parameters of the document. In an embodiment in accordance with the invention, the workflow order may be impromptu or dynamic, for example, corresponding to the order in which the edits are received from a user (e.g., a time entered in the metadata of a part or the user's map file).

Encrypted version 226 may be a copy of encrypted version 210 updated with edit parts 242 generated by user 206 or generated directly from secure document 202 for independent editing by users 206 and 208. Encrypted version 226 may be loaded on storage 228 (e.g. such as on a computer hard drive on a server or other computer), which may be unsecured. User 208 may have received (e.g. via a disk or email from user 206) a copy of encrypted version 226. User 208 may download encrypted version 226 onto storage 228.

User 208 may access encrypted version 226 using processor 232 (e.g., running an application program having a document interface 232). Processor 232 may decrypt encrypted version 226 to generate decrypted version 234. Decrypted version 234 may include unencrypted material (clear-text copies) of content from encrypted version 226 that user 208 may be permitted to access.

Decrypted version 234 may exist in transient storage or may be in permanent storage depending on document sensitivity and security of access devices. Transient storage may be, for example, the RAM of user computer 236. Decrypted version 234 may exist while user 208 operates an editing application program (e.g. to review, edit, or alter the document).

User 208 may have exclusive access to decrypted version 234 as the program runs. When the application program editing decrypted version 234 is terminated, decrypted version 234 may be erased and/or lost, such that no copy may be available.

User 208 may provide input to the document (e.g. adding, deleting or editing content) by generating edited content 248 in decrypted version 234. Upon completion of an editing session by the user 208, (or upon entry of a “save” command), processor 232 may save the edits to content retrieved from an original document part 240 (e.g., part A) to an edit part 244 associated with user 208 and that original part (A) back into the encrypted version 226, creating an updated version of encrypted version 226 without altering the original content part 240. User 208 may not have editing, but only viewing (e.g., RO) access to the original document part 240 and may have full editing (e.g., RW) access to the associated edit parts 244. Once edits are generated, they are encrypted and signed (e.g., edit part 244 is encrypted and signed). User 208 may proceed to edit other parts B, . . . Z in decrypted version 234 of the document, saving her/his edits in a plurality of individually addressable edit parts B2, . . . Z2, respectively, in the encrypted version 226. The original content parts A, . . . Z in the encrypted version 226 may remain unaltered. At the end of a user's 208 editing session, the application may close and processor 232 may erase decrypted version 234 from user computer 236 and may also deactivate user's 208 keys.

When document workflow 200 receives edits executed by one user 208 after another user 206 in respective sequential iterations, for example, as illustrated in FIG. 2, sequential edit parts 242 and 244 may be accumulated in each user's copy of the encrypted version 226 and passed on to the next user in each sequential iteration. As the encrypted version is passed from user to user in the workflow, each user uploads her/his edits parts to collect a sequence of edit parts stored separate from each original part.

This process and system may repeat in a new iteration 246 for each additional user in the document workflow.

When document workflow 200 edits encrypted version in parallel, multiple versions of encrypted version 210, 226 may accumulate different edit parts 242, 244 generated by different users 206, 208, respectively.

Each user's 206, 208 edit parts 242 and 244 may be imported and merged into the secure document 202 by user computers 224, 236, respectively. The edits may be imported during/after each user's iteration 248 and/or at the end of the workflow 250 (after the last user's iteration). When encrypted versions 210, 226 are edited in parallel, edit parts 242 and 244 may be imported from multiple encrypted versions 210, 226.

Editing may be additive such that each user's edits add editing information to the encrypted version 210, 226 and never remove information (another user's edits) from the encrypted version 210, 226 (although the edits themselves may delete other user's added material). Since each user's edits are stored separately and no other user may alter the user's edits, a complete record is kept of each user's contribution to the collaborative editing workflow for complete user accountability.

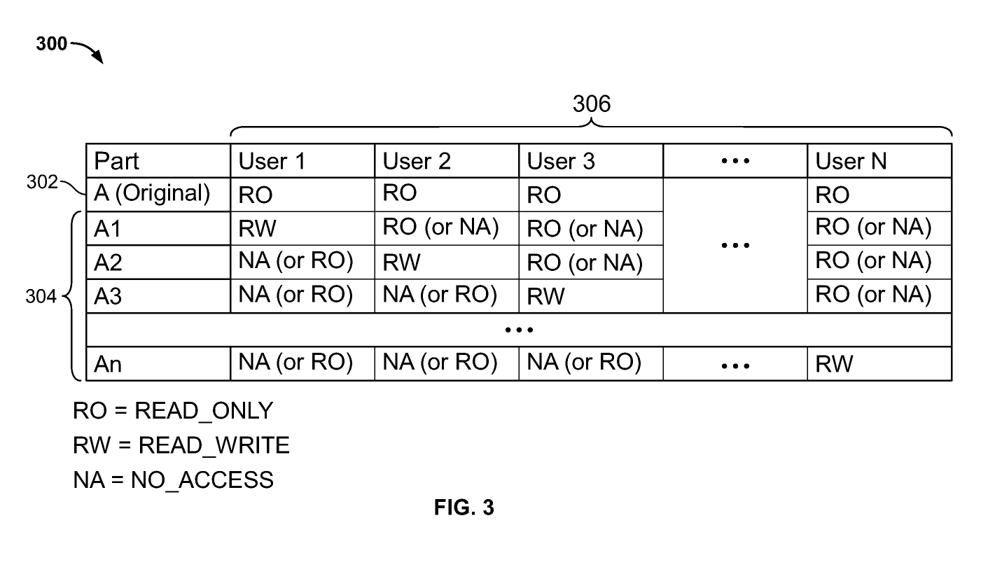

FIG. 3 illustrates an access table 300 listing access rights for a plurality of users to access a single part of a composite document, in accordance with an embodiment of the invention. The composite document (e.g. composite document 102 of FIG. 1) may be composed of a plurality of original parts. A plurality of access tables similar to access table 300 may be used to represent access rights to a plurality of original parts. Each access table 300 may represent the type of access granted to each user for an original part. Access to that original part may be provided via keys assigned to each user. The keys may be embedded in, or linked to, the table or may be accessed via a separate unit (e.g., access information (e.g. map files) 106 and entry information 108 (e.g. entry table) of FIG. 1).

Each original (unedited) part 302 (e.g., part A) of the composite document may be associated with a sequence of edit parts 304 (partial edits Ai, i=1, . . . n), each of which may be associated with a different one of a plurality of users 306 (workflow participants Ui, i=1, . . . n), for editing the original part 302. Edit parts Ai may be initially empty and may be filled with edits from associated users, Ui. When the document is opened by a user Uj, a decrypted (clear-text) version may be compiled on the user's computer displaying edits (e.g., to part A) from previously generated edit parts (e.g., Ai, i=1, . . . j-1), for which the user has viewing (RO) access and not displaying edits for which the user has no access (NA).

The edits may be applied in the order in which the edits are generated in the workflow, for example, to recreate the accumulation of those changes as they existed in the version of the document generated by the previous user Uj-1.

To preserve user traceability, one user Ui cannot modify another user Uj's edit parts Aj, for i≠j. That is, the edit parts Ai do not overwrite each other. For example, all edit parts Ai as well as the original part A may be securely stored. Only a single user Ui may access keys to modify edit parts Ai and no user may edit another user's part or the original part A. In this way, the history of edits Ai, . . . , Zi for which each user Ui is solely responsible is recorded in the edited content for user accountability in a shared editing environment. It may be appreciated that, although a user may not edit another user's editing part, the edit parts themselves may store edits that conflict or modify each other. For example, edit part Ai+1 generated by user Ui+1 may delete material added into the document by user Ui in part Ai.

Each user Uj may not have RW access to the edit part Ai associated with another user, but may have RO access or no access. FIG. 3 illustrates that each user Ui may view edits (e.g., RO access) generated by preceding users U1, . . . , Ui-1, but may not view edits (e.g., NA access) generated by subsequent users Ui+1, . . . , UN. In another embodiment in accordance with the invention, each user Ui may not view edits generated by preceding users (e.g., having NA access), for example, to generate independent feedback from all users unaffected by other users' edits. In another embodiment, each user Ui may view edits generated by subsequent users (e.g., having RO access), for example, after the user adds his or her own edits to track the progress of the document and possibly re-enter the workflow a second time. In still another embodiment, a user may only view subsequent edits that conflict with edits generated by that user, for example, to approve/disapprove the conflicting edit or propose alternate edits.

An embodiment in accordance with the invention may use a plurality of different access modes for different edits (Ai) made to each part (A) by each user (Ui). The plurality of different access modes for edit parts may correspond to the order that the edit part is generated in the workflow relative to the user's edit part. For example, the user may have full editing (RW) access to the user's own edit part, viewing access (RO) to edit parts generated by previous users and no access (NA) to edit parts generated by subsequent users in the workflow. Other access rights may be used and access rights may be universally used for groups of users or may be individually set for each user.

The individual access modes for each part for each user may change or fluctuate during the workflow, for example, depending on the stage of the workflow. For example, a user may have editing (RW) access to the edit part designated for the user only during the user's turn to edit in the workflow. In another example, a user may initially have viewing (RO) access for an original part, but once the user enters (e.g., saves or completes) edits, the access rights may be revoked to no access (NA).

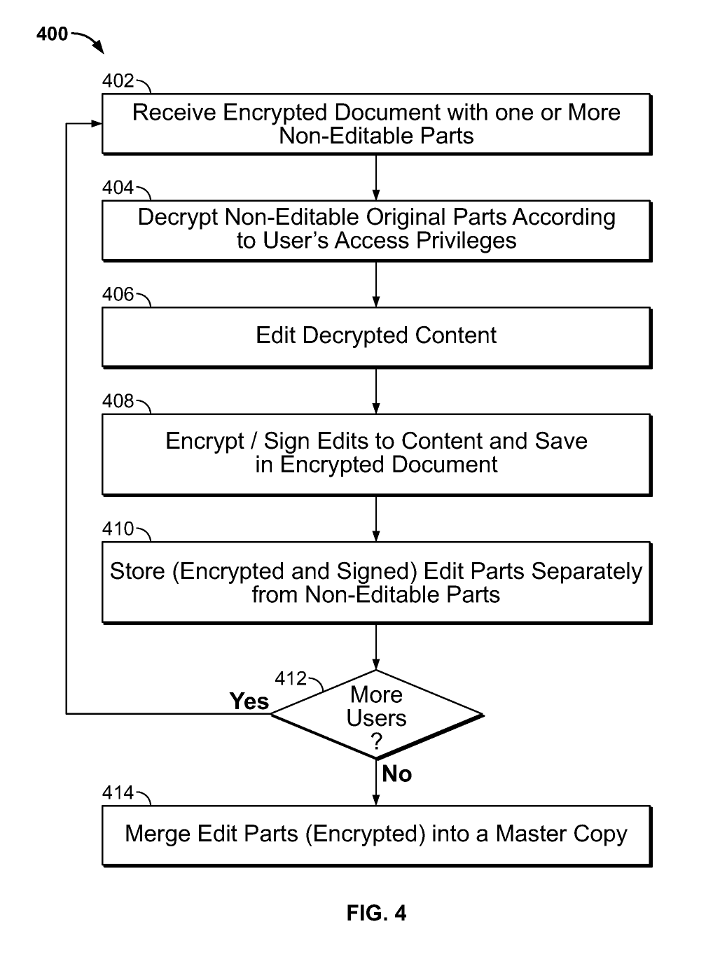

FIG. 4 illustrates process 400 for editing a document by multiple users in a workflow, according to an embodiment of the invention.

In operation 402, a processor (e.g. such as processor 220, FIG. 2) may receive an encrypted version of a document, e.g. a .pex version of the document, with individually encrypted and/or signed parts. The encrypted document may have a plurality of non-editable original parts, A, B, C, . . . (e.g., only RO or NA access keys, but no RW access keys). The encrypted document may also have a plurality of edit parts for storing edits to the original document parts generated by a plurality of users. Each edit part may be editable by a unique associated single one of the plurality of users and non-editable by all other of the plurality of users. Non-editable parts may not be edited themselves, but the material in these parts may be edited and stored in a separate edit part. Non-editable parts may have Restricted Read/Write (RRW) access, where only RO access is given to the non-editable document part and RW access is given to a separately stored edit part pre-designated to store the edits associated with that user and that non-editable document part.

The encrypted document may be generated from a secure document (e.g. by processor 212, FIG. 2). The secure document may be for example a composite document and may be maintained in a secure computer environment, such as in a firewall protected environment. The encrypted document may have been generated automatically by an electronic workflow system to execute a set of tasks according to a workflow, where users are workflow participants. The processor may for example allow all of the users to access the encrypted document, e.g. placing it on a server, or the processor may make the encrypted document available to one user, e.g. by sending it to the user by email. The user(s) may download the encrypted document to a storage unit, such as an unsecured storage. The encrypted document may have a structure as illustrated in FIG. 1.

In operation 404, the user (e.g. using a processor such as 220, FIG. 2) may decrypt the encrypted non-editable original parts of the encrypted document in operation 402, to which the user is granted viewing (RO) access (e.g., in access information 106, FIG. 1). The user may decrypt the encrypted document to generate a decrypted version of the document according to the user's access privileges. The decrypted document may be created and may exist (e.g. on user computer 236, FIG. 2) in a transient storage such as processor RAM. The decrypted document may exist while user is operating an application to edit or alter the document.

In operation 406, the user may edit the decrypted document version of content from the encrypted non-editable original parts. The user may provide input (e.g. adding, deleting and/or editing content) through the decrypted document (e.g. in transient memory).

In operation 408, the edits made during operation 406 may be collected, e.g. by a processor operating an application program. Upon a user's completion of an editing session, (or, for example, upon a user's input of a “save” command), the application may save the edits into an encrypted version of the document in an edit part pre-designated for the user and associated with (but separate from) the original non-editable document part, creating an updated version of the encrypted document without altering the original version of the content in the non-editable original part. For example, to save the edits, the processor (operating a document interface) may encrypt the altered content parts and sign the encryptions. At the end of a user's session, the application may close and the decrypted document may be erased (e.g. by the document interface) from transient storage.

In operation 410, the user may store the encrypted and signed edits parts separately from the original document parts.

In operation 412, a processor, such as one operating an electronic workflow system, may determine if an additional user is to access the document. If so, the process or processor, may return to operation 402 to make the encrypted version of the document (now with the previous user's edit parts for collaborative editing or without the previous user's edit parts for independent editing) available to another user. That user (and others) may follow operations 402-410 to further edit the document according to the user's permissions. In some systems, operation 412 may be skipped and no central processor may determine if there exist additional workflow users. Instead, the document may be freely sent between users or multiple copies may be distributed and edited by users in any order.

If in operation 412, there are no further users who need to access the document, a processor, such as a processor at the location of the secure document may, in operation 414, import the most recently updated version of the encrypted document to a secure environment. In operation 414, the processor may import either a single copy of the encrypted document (containing all of the user's edits/changes for collaborative editing) or multiple copies of the encrypted document (which may have been provided to the users for independent editing). In operation 414, the processor may, for example, verify the signatures on all of the changes and upon verification, merge the changes into the secure document. The edits may be merged as separate edit parts or incorporated into the original content material. Upon import, the secure document and the one or more copies of the encrypted document may be kept and/or merged or the encrypted document may overwrite the secure document, for example, in accordance with any predefined rules of the document.

To coordinate the workflow and allow users to build on previous user's edits, access information files may provide each user with different accesses to different versions of the same material, for example, including original content parts and edit parts. For example, a user (Ui) may only have viewing (RO) access to the original content parts to maintain them in their original forms and may have editing (RW) access to his or her own editing part (Ai) to alter it to store the edits associated with the non-editable original part (A). Furthermore, the user (Ui) may have viewing access (or no access) to edit parts for other preceding users (U1, . . . , Ui-1) in the workflow and no access (or viewing access) to edit parts for other subsequent users (Ui+1, . . . , Un) in the workflow.

Other operations or orders of operations may be used.

It may be appreciated that the term “user” as it is used herein may refer to any one or more individuals or computing devices linked to a profile or account. Each user, profile, or account may have access information to access (or not access) a composite document or other shared document material. The user, profile, or account may, include for example, one or more computers in a network, Access Points (APs), Internet Protocol (IP) addresses, individual people, teams, companies, corporations, or any combination or sub-group thereof.

Unless specifically stated otherwise, as apparent from the discussion above, it is appreciated that throughout the specification discussions utilizing terms such as “processing,” “computing,” “calculating,” “determining,” or the like, refer to the action and/or processes of a computer or computing system, or similar electronic computing device, for example comprising processors, that manipulate and/or transform data represented as physical, such as electronic, quantities within the computing system's registers and/or memories into other data similarly represented as physical quantities within the computing system's memories, registers or other such information storage, transmission or display devices.

An embodiment in accordance with the invention may be implemented, for example, using a non-transitory computer readable medium or article which may store an instruction or a set of instructions that, if executed by a machine having a processor, cause the processor to perform a method and/or operations in accordance with embodiments of the invention. Such a machine having a processor may include, for example, any suitable processing platform, computing platform, computing device, processing device, computing system, processing system, computer, processor, or the like, and may be implemented using any suitable combination of hardware and/or software. The non-transitory computer-readable medium or article may include, for example, any suitable type of memory unit, memory device, memory article, memory medium, storage device, storage article, storage medium and/or storage unit, e.g., memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), a tape, a cassette, or the like. The instructions may include any suitable type of code, for example, source code, target code, compiled code, interpreted code, executable code, static code, dynamic code, or the like, and may be implemented using any suitable high-level, low-level, object-oriented, visual, compiled and/or interpreted programming languages like C, C++, Java, BASIC, Pascal, Fortran, COBOL, assembly language, machine code, or the like.

Pending International Patent Application Serial No. PCT/US2010/049638, titled, PROVIDING DIFFERENTIAL ACCESS TO A DIGITAL DOCUMENT, filed Sep. 21, 2010 (bearing HP docket number 201000332-1), Pending International Patent Application Serial No. PCT/US2010/049669, titled, APPLICATION OF DIFFERENTIAL POLICIES TO AT LEAST ONE DIGITAL DOCUMENT, filed Sep. 21, 2010 (bearing HP docket number 201000333-1) and Pending U.S. Patent Application Ser. No. 12/949510, filed Nov. 18, 2010 (bearing HP docket number 201000358-1) are each hereby incorporated by reference in their entirety. Embodiments of the present invention may be implemented as described in or in conjunction with embodiments described in each of the incorporated references.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

We claim:

1. A method for collaboratively editing a composite document having a plurality of original document parts, the method comprising:
for each of one or more original document parts:
storing a non-editable version of the original document part;
storing edits to the original document part in a plurality of edit parts, wherein each of the plurality of edit parts is editable by a single associated one of a plurality of users and non-editable by all other users of the plurality of users; and
individually encrypting the plurality of edit parts and storing the edit parts separately from the original document parts.

2. The method of claim 1, wherein each edit part is individually encrypted by a unique part-specific encryption key.

3. The method of claim 1, further comprising individually signing each edit part by a unique part-specific signature.

4. The method of claim 1, further comprising individually decrypting the individually encrypted edit parts to generate a clear text version of content from the original document part incorporating the edits cumulatively stored in the plurality of associated edit parts.

5. The method of claim 1, wherein each user may be individually assigned access rights to view and edit each part of the composite document on a part-by-part basis.

6. The method of claim 1, wherein in each stage in a workflow a sequential one of the plurality of users stores edits in the associated edit part.

7. The method of claim 1, wherein the edit parts are initially empty and are updated with edits generated by the associated one of the plurality of users.

8. The method of claim 1, wherein the edit parts store edits relative to the original document part.

9. The method of claim 1, wherein edit parts store edits relative to another edit part.

10. The method of claim 1, wherein each user has a plurality of different access rights to the plurality of edit parts associated with each original document part.

11. The method of claim 10, wherein each user is assigned decryption but not encryption keys for viewing but not editing the non-editable version of the original document part and encryption keys for editing the associated editable edit parts.

12. A system for a plurality of users to edit a composite document, comprising:
one or more memories to store:
one or more non-editable original parts of the composite document,
a plurality of edit parts for storing edits to a non-editable original part, wherein each of the plurality of edit parts is editable by a single associated one of the plurality of users and non-editable by all other of the plurality of users, and
one or more access information files to provide access individually to each user for each part of composite document, wherein the access information files provide each of the plurality of users with access to edit the plurality of edit parts associated therewith, no access to edit the one or more edit parts associated with other users, and access to view but not edit the original parts; and
a document interface to locate the access information file corresponding to a user and to provide the user with a version of the composite document having parts accessed by the corresponding access information file.

13. The system of claim 12, wherein the one or more memories store the composite document in an encrypted version of the original parts and edit parts and the access information files include encryption keys to edit the edit parts associated therewith, decryption or no keys to view or not view the edit parts associated with other users, and decryption keys but not encryption keys to view but not edit the original parts.

14. The system of claim 12, wherein the one or more memories comprise a plurality of individually addressable memory units to store the original parts and each of the edit parts separately.

15. The system of claim 12, comprising a transient memory for storing a decrypted version of the composite document where the cumulative edits from the associated edit parts are applied to each original part.

16. The system of claim 12, wherein the access information file individually assigns each user access rights to view and edit each part of the composite document on a part-by-part basis.

17. The system of claim 12, wherein each access information file defines a plurality of different access rights for a single user for the plurality of edit parts associated with each original part.

18. The system of claim 12, wherein the access information files include map files.

19. A non-transitory computer-readable medium having stored thereon instructions which when executed by a processor cause the processor to perform the method of:
for each of one or more original document parts in a composite document having a plurality of original document parts:
storing a non-editable version of the original document part;
storing edits to the original document part in a plurality of edit parts, wherein each of the plurality of edit parts is editable by a single associated one of a plurality of users and non-editable by all other users of the plurality of users; and
encrypting the plurality of edit parts and storing the edit parts separately from the original document parts.

20. The non-transitory computer-readable medium of claim 19, wherein the instructions cause the processor to decrypt the encrypted edit parts to generate a clear text version of content from the original document part incorporating the edits cumulatively stored in the plurality of associated edit parts.
